(19) United States
(12) Patent Application Publication
(10) Pub. No.: US 2018/0106103 A1
(43) Pub. Date: Apr. 19, 2018

(54) DISPLAY APPARATUS

(71) Applicant: BOE TECHNOLOGY GROUP CO., LTD., Beijing (CN)

(72) Inventor: Zhihong DU, Beijing (CN)

(21) Appl. No.: 15/520,226

(22) PCT Filed: Oct. 24, 2016
(86) PCT No.: PCT/CN2016/103007

§ 371 Date: Apr. 19, 2017

(30) Foreign Application Priority Data
Jan. 4, 2016 (CN) 201610004727.6

(51) Int. Cl. E06B 9/72; E06B 9/42; F21V 3/02

(52) U.S. Cl. CPC E06B 9/72; E06B 2009/6809; F21V 3/02; E06B 9/42

(57) ABSTRACT

A display apparatus includes a transparent display panel, and a roller shutter device which is arranged behind the transparent display panel (100) and can be switched between two states of rolling up and flattening a back which shields the transparent display panel. By using the roller shutter device arranged behind the transparent display panel, switching between transparent display and nontransparent display is achieved.

### TECHNICAL FIELD

Embodiments of the present disclosure relate to a display apparatus.

### BACKGROUND

Transparent display is an important development direction of display apparatus, and in order to implement switching between transparent display and non-transparent display in the display apparatus, some components (e.g., a liquid crystal grating or the like) which can be switched between a light-transmitting state and a non-light-transmitting state are mounted on a transparent display screen, so the display apparatus is relatively complex in structure and is unbeneficial for saving production cost.

### SUMMARY

Embodiments of the present disclosure provide a display apparatus.

The display apparatus includes a transparent display panel, and a roller shutter device which is arranged behind the transparent display panel and can be switched between two states of rolling up and flattening a back which shields the transparent display panel.

For example, the roller shutter device includes: a roller shutter, a rolling drum fixed with an upper hem of the roller shutter, a lower hem fixed with a lower edge of the roller shutter, and a tubular motor configured to drive the rolling drum to rotate.

For example, the tubular motor includes: a motor fixing seat configured to fix the tubular motor; a tubular motor housing connected with the motor fixing seat; and a control portion configured to control an opening amplitude of the roller shutter, a brake control portion configured to control a rotating shaft to stop rotating, a stator and a rotor configured to convert electric energy into kinetic energy, a rotating shaft configured to rotate at a preset rotating speed in a preset rotating direction, a rotating speed control portion configured to control a rotating speed of the rotating shaft, and a motor output shaft exposed out of the tubular motor housing at one end, fixed with the rolling drum and configured to transfer the kinetic energy to the rolling drum, which are arranged in the tubular motor housing. The control portion is connected with the brake control portion, the brake control portion is connected with the stator and the rotor, the stator and the rotor are connected with one end of the rotating shaft, and the other end of the rotating shaft is connected to the output shaft through the rotating speed control portion.

For example, the tubular motor further includes: at least one of a first signal receiving portion configured to receive a wireless control signal and a second signal receiving portion configured to receive a wired control signal.

For example, the roller shutter is a curtain made of a flexible white reflective material.

For example, the transparent display panel is a splicing screen or an integrated screen.

For example, the transparent display panel is an electroluminescent display panel, or a liquid crystal display panel.

For example, the display apparatus further includes a light source arranged between the roller shutter device and the transparent display panel.

For example, the display apparatus further includes a diffusion sheet arranged on an emergent side of the light source.

For example, the light source is arranged on at least one side of the transparent display panel.

### BRIEF DESCRIPTION OF THE DRAWINGS

Embodiments of the present disclosure will be described in more detail below with reference to accompanying drawings to allow an ordinary skill in the art to more clearly understand embodiments of the present disclosure, in which:

FIG. 1a is an exploded structural schematic diagram of a display apparatus provided by an embodiment of the present disclosure in the transparent display state;

FIG. 1b is an exploded structural schematic diagram of the display apparatus provided by the embodiment of the present disclosure in the non-transparent display state;

FIG. 2 is a structural schematic diagram of a tubular motor in the display apparatus provided by an embodiment of the present disclosure; and

FIG. 3 is an exploded structural schematic diagram of the display apparatus provided by the embodiment of the present disclosure when the transparent display panel is a splicing screen.

### DETAILED DESCRIPTION

Technical solutions according to the embodiments of the present disclosure will be described clearly and fully as below in conjunction with the accompanying drawings of embodiments of the present disclosure. It is apparent that the described embodiments are just a part but not all of the embodiments of the disclosure. Based on the described embodiments herein, a person of ordinary skill in the art can obtain other embodiment(s), without any creative work, which shall be within the scope of the present disclosure.

Shape and size of each part or component in the drawings of the present disclosure do not reflect the true scale of display apparatuses, which only aim to schematically illustrate contents of the present disclosure.

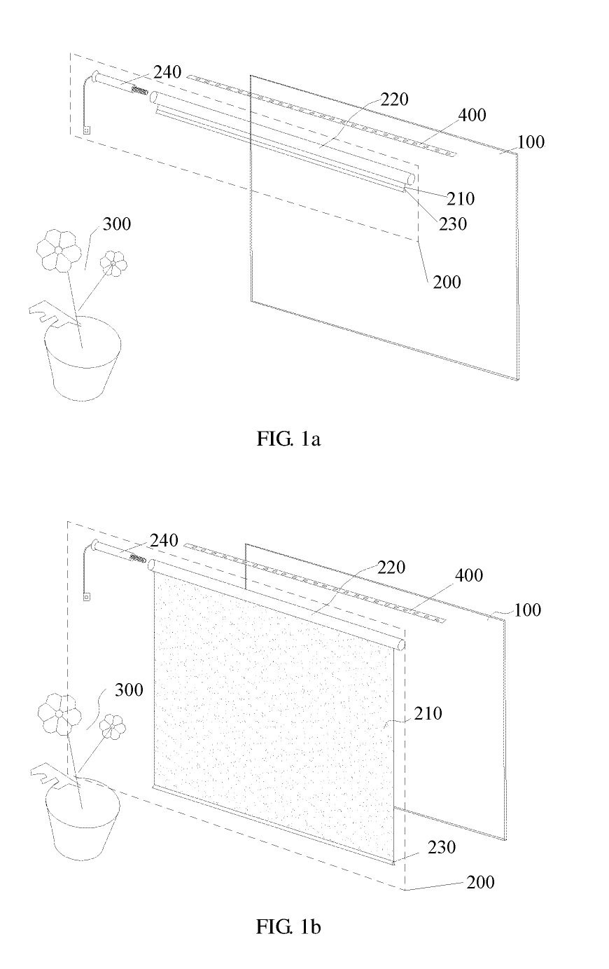

An embodiment of the present disclosure provides a display apparatus, as shown in FIG. 1a and FIG. 1b, including: a transparent display panel 100, and a roller shutter device 200 which is arranged behind the transparent display panel 100 and can be switched between two states of rolling up and flattening a back which shields the transparent display panel 100.

The display apparatus provided by the embodiment of the present disclosure achieves switching between transparent display and non-transparent display by the roller shutter device 200 arranged behind the transparent display panel 100. For example, as shown in FIG. 1a, when transparent display needs to be carried out, the roller shutter can be rolled up to expose an article 300 placed behind the transparent display panel 100; and as shown in FIG 1b, when non-transparent display needs to be carried out, the roller shutter can be flattened to shield the article 300 placed behind the transparent display panel 100. The display apparatus adopts the roller shutter device 200 to achieve switching between transparent display and non-transparent display, which has advantages of convenient and rapid implementation, and low production cost.

For example, the roller shutter device 200 in the display apparatus provided by the embodiment of the present disclosure, as shown in FIG. 1a and FIG. 1b, may include: a roller shutter 210, a rolling drum 220 fixed with an upper hem of the roller shutter 210, a lower hem 230 fixed with a lower edge of the roller shutter 210, and a tubular motor 240 for driving the rolling drum 220 to rotate.

For example, in the roller shutter device 200 of the display apparatus provided by the embodiment of the present disclosure, the roller shutter 210 is provided with a curtain made of a flexible white reflective material. The curtain may be one of: 1) a PVC (polyvinyl chloride) plastic soft curtain; 2) a curtain with the base fabric formed by weaving textile threads and a surface layer being coated with PVC material having diffuse reflection effect; and 3) a curtain with the base fabric formed by weaving glass threads and a surface layer being coated with a PVC coating having the diffuse reflection effect, however, the embodiments of the present disclosure are not limited thereto.

When nontransparent display needs to be carried out, the tubular motor 240 drives the rolling drum 220 to rotate, the roller shutter 210 is flattened, light is shielded by the curtain, and a viewer cannot see the article 300 positioned behind the transparent display panel 100. When transparent display needs to be carried out, the tubular motor 240 drives the rolling drum 220 to rotate, the roller shutter 210 is rolled up, the light is not shielded by the curtain, and the viewer can see the article 300 behind the transparent display panel 100.

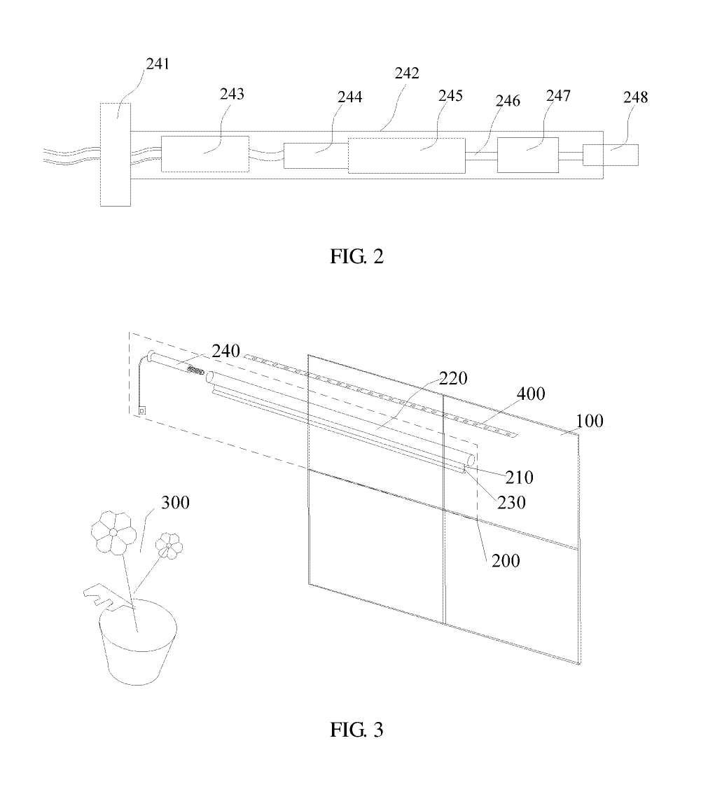

For example, the tubular motor 240 in the roller shutter device 200 of the display apparatus provided by the embodiment of the present disclosure, as shown in FIG. 2, includes: a motor fixing seat 241 configured to fix the tubular motor 240; a tubular motor housing 242 connected with the motor fixing seat 241; and a stroke control portion 243 configured to control an opening amplitude of the roller shutter 210, a brake control portion 244 configured to control a rotating shaft 246 to stop rotating, a stator and a rotor 245 configured to convert electric energy into mechanical energy, the rotating shaft 246 configured to rotate at a preset rotating speed in a preset rotating direction, a rotating speed control portion 247 configured to control a rotating speed of the rotating shaft 246 and a output shaft 248 exposed out of the tubular motor housing 242 at one end, fixed with the rolling drum 220 and configured to transfer kinetic energy to the rolling drum 220, which are arranged inside the tubular motor housing 242.

The stroke control portion 243 is connected with the brake control portion 244, the brake control portion 244 is connected with the stator and the rotor 245 of the motor, the stator and rotor 245 is connected with one end of the rotating shaft 246, and the other end of the rotating shaft 246 is connected to the motor output shaft 248 through the rotating speed control portion 247 of the motor.

For example, the stroke control portion 243 of the roller shutter controls the opening amplitude of the roller shutter to prevent damage to the tubular motor 240 due to an excessively large stroke, and controls the rotating direction of the tubular motor 240 to determine opening and closing of the roller shutter. The brake control portion 244 of the motor allows the tubular motor 240 to reliably stop moving according to an instruction at any time and to keep the tubular motor 240 in a state in the process of driving a load to operate. The rotating speed control portion 247 of the motor can reduce the rotating speed and increase a torque, and it also has functions of changing a motion direction, achieving different rotating speeds, or the like.

For example, the tubular motor 240 in the roller shutter device 200 of the display apparatus provided by the embodiment of the present disclosure may also be controlled by at least one of wireless and wired remote controllers. In this case, the tubular motor 240 may also include at least one of a first signal receiving portion configured to receive a wireless control signal and a second signal receiving portion configured to receive a wired control signal.

For example, the transparent display panel 100 in the display apparatus provided by the embodiment of the present disclosure may adopt an integrated screen as shown in FIG. 1a and FIG. 1b, or it may adopt a splicing screen as shown in FIG. 3. When the splicing screen is adopted, narrow-frame or no-frame display screens can be spliced to form the splicing screen.

For example, according to the transparent display panel 100 in the display apparatus provided by the embodiment of the present disclosure, an electroluminescent display panel may be used as the transparent display panel 100, or a liquid crystal display panel may be used as the transparent display panel 100, however, the embodiments of the present disclosure are not limited thereto. For example, display screens in other modes may also be used as the transparent display panel 100.

In addition, when the liquid crystal display panel is used as the transparent display panel 100, a backlight module including parts, e.g., a light guide plate and the like, generally cannot be arranged on an incident side of the liquid crystal display panel.

For example, the display apparatus provided by the embodiment of the present disclosure, as shown in FIG. 1a and FIG. 1b, may further include: a light source 400 arranged between the roller shutter device 200 and the transparent display panel 100. When transparent display is carried out, the light source 400 may be in a closed state, or it may be in an open state, and is configured to illuminate the article 300 behind the transparent display panel 100 and the transparent display panel 100 for carrying out display; and when non-transparent display is carried out, the light source 400 may be in the closed state, or it may be in the open state, and is configured to illuminate the transparent display panel 100 for carrying out display.

For example, the light source 400 in the display apparatus provided by the embodiment of the present disclosure is arranged on at least one side edge of the transparent display panel 100. For example, as shown in FIG. 1a and FIG. 1b, a row of lamps can be arranged on one side of the transparent display panel 100, or a group of lamps can be arranged around the transparent display panel 100. The light source 400 may be an LED (Light-Emitting Diode) lamp or, may be an incandescent lamp, however, the embodiments of the present disclosure are not limited thereto. Moreover, the light source 400 may be a white light source, or may be a single-color light source, however, the embodiments of the present disclosure are not limited thereto.

For example, to increase light emitting uniformity of the light source 400, in the display apparatus provided by the embodiment of the present disclosure, a diffusion plate may also be arranged on an emergent face of the light source 400.

The display apparatus provided by the embodiments of the present disclosure includes: a transparent display panel, and a roller shutter device which is arranged behind the transparent display panel and can be switched between two states of rolling up and flattening a back which shields the transparent display panel. By using the roller shutter device arranged behind the transparent display panel, switching between transparent display and non-transparent display can be achieved. For example, when transparent display needs to be carried out, the roller shutter can be rolled up to expose an article placed behind the transparent display apparatus, and when non-transparent display needs to be carried out, the roller shutter can be flattened to shield the article placed behind the transparent display panel. The display apparatus adopts the roller shutter device 200 to achieve switching between transparent display and non-transparent display, which has advantages of convenient implementation and low production cost.

The described above are only exemplary embodiments of the present disclosure, and the present disclosure is not intended to be limited thereto. For one of ordinary skill in the art, various changes and alternations may be readily contemplated without departing from the technical scope of the embodiments of the present disclosure, and all of these changes and alternations shall fall within the scope of the present disclosure.

The present application claims priority to the Chinese patent application No. 201610004727.6 filed to the State Intellectual Property Office (SIPO) on Jan. 4, 2016, and entitled “DISPLAY APPARATUS,” the disclosure of which is incorporated herein by reference in its entirety as part of the present application.

1. A display apparatus, comprising: a transparent display panel, and a roller shutter device which is arranged behind the transparent display panel and can be switched between two states of rolling up and flattening a back which shields the transparent display panel.

2. The display apparatus according to claim 1, wherein the roller shutter device includes: a roller shutter, a rolling drum fixed with an upper hem of the roller shutter, a lower hem fixed with a lower edge of the roller shutter, and a tubular motor configured to drive the rolling drum to rotate.

3. The display apparatus according to claim 2, wherein the tubular motor includes:
a motor fixing seat configured to fix the tubular motor;
a tubular motor housing connected with the motor fixing seat; and
a stroke control portion configured to control an opening amplitude of the roller shutter, a brake control portion configured to control a rotating shaft to stop rotating, a stator and a rotor configured to convert electric energy into kinetic energy, a rotating shaft configured to rotate at a preset rotating speed in a preset rotating direction, a rotating speed control portion configured to control a rotating speed of the rotating shaft, and a motor output shaft exposed out of the tubular motor housing at one end, fixed with the rolling drum and configured to transfer the kinetic energy to the rolling drum, which are arranged in the tubular motor housing;
wherein the control portion is connected with the brake control portion, the brake control portion is connected with the stator and the rotor, the stator and the rotor are connected with one end of the rotating shaft, and the other end of the rotating shaft is connected to the output shaft through the rotating speed control portion.

4. The display apparatus according to claim 3, wherein the tubular motor further includes: at least one of a first signal receiving portion configured to receive a wireless control signal and a second signal receiving portion configured to receive a wired control signal.

5. The display apparatus according to claim 2, wherein the roller shutter is a curtain made of a flexible white reflective material.

6. The display apparatus according to claim 5, wherein the transparent display panel is a splicing screen, or an integrated screen.

7. The display apparatus according to claim 5, wherein the transparent display panel is an electroluminescent display panel, or a liquid crystal display panel.

8. The display apparatus according to claim 7, further comprising: a light source arranged between the roller shutter device and the transparent display panel.

9. The display apparatus according to claim 8, further comprising: a diffusion sheet arranged on an emergent side of the light source.

10. The display apparatus according to claim 8, wherein the light source is arranged on at least one side of the transparent display panel.

11. The display apparatus according to claim 3, wherein the roller shutter is a curtain made of a flexible white reflective material.

12. The display apparatus according to claim 4, wherein the roller shutter is a curtain made of a flexible white reflective material.

13. The display apparatus according to claim 5, wherein the curtain is one of a PVC (polyvinyl chloride) plastic soft curtain; a curtain with the base fabric formed by weaving textile threads and a surface layer being coated with PVC material having diffuse reflection effect; or a curtain with the base fabric formed by weaving glass threads and a surface layer being coated with a PVC coating having the diffuse reflection effect.

14. The display apparatus according to claim 1, wherein the transparent display panel is a splicing screen or an integrated screen.

15. The display apparatus according to claim 14, wherein the transparent display panel is an electroluminescent display panel, or a liquid crystal display panel.

16. The display apparatus according to claim 15, further comprising: a light source arranged between the roller shutter device and the transparent display panel.

17. The display apparatus according to claim 16, further comprising: a diffusion sheet arranged on an emergent side of the light source.

18. The display apparatus according to claim 17, wherein the light source is arranged on at least one side of the transparent display panel.
